(19) United States
(12) Patent Application Publication
(10) Pub. No.: US 2009/0205928 A1
(43) Pub. Date: Aug. 20, 2009

(54) Electronic Coin Checker

(75) Inventor: Roland Griese, Berlin (DE)

Correspondence Address: FAY KAPLUN & MARCIN, LLP, 150 BROADWAY, SUITE 702, NEW YORK, NY, 10038, US

(73) Assignee: WALTER HANKE MECHANISCHE WERKSTÄTTEN GMBH & CO. KG, Berlin (DE)

(21) Appl. No.: 11/813,366

(22) PCT Filed: Jan. 3, 2006
(86) PCT No.: PCT/EP06/00109

§ 371 Date: Nov. 12, 2008

(30) Foreign Application Priority Data
Jan. 5, 2005 (DE) 10 2005 001 088.1

(51) Int. Cl. G07F 1/04

(52) U.S. Cl. 194/346

(57) ABSTRACT

An electronic coin checker is disclosed, comprising a coin insert, a coin running track, in the region of which at least one checking device, for checking the coins, is arranged and a deflector. According to the result from the checking device, the deflector may be placed in a withdrawn position, opening the acceptance channel, or in an extended position, in which the coin is deflected into a return channel which ends in a return opening in the front region of the coin checker. The deflector comprises means for clamping which clamp a false coin introduced through the return opening in the extended state of the deflector, by means of withdrawing the deflector.

### FIELD OF THE INVENTION

The present invention relates to an electronic coin tester.

### BACKGROUND OF THE INVENTION

Electronic coin testers are generally known, and usually comprise a housing which is provided with a coin insert to which a coin run-in connects. Usually, test sensor arrangements are provided in the region of the coin run-in channel, which test an inserted coin with regard to its material characteristics, its size or other characteristics. A switching mechanism is activated by a control device, depending on the results of the testing, wherein the switching mechanism usually comprises a deflection element and an electromagnet. The deflection element is actuated by the electromagnet, between a position releasing an acceptance channel and a return position. In the known manner, the deflection element may be designed as a strip-like runner track piece which in the idle condition of the electromagnet is a component part of a return channel or return runner track, and which is retracted, i.e. pulled out of the return channel on activation of the electromagnet, in a manner such that the acceptance channel is released. With the known electronic coin tester, the return channel ends in a return opening, which is accessible to the user at a narrow front plate, for the removal of returned coins.

It has been found that false coins, with malicious intent, have been inserted through the return opening into the return channel up to the deflection element, and that a valid coin has been inserted into the coin insert channel, so that the deflection element has been retracted and the false coin gotten into the acceptance channel, and was then acknowledged by the light sensor below the deflector. On account of this, the subsequent authentic coin hits the deflector and thus rolls again into the return. In this manner, false coins may circumvent the testing by way of testing sensor device.

### SUMMARY OF THE INVENTION

The present invention relates to a coin tester with a return channel open to the front plate of the coin tester, with which one avoids a false coin getting into the acceptance channel via the return channel.

By way of the fact that the deflector comprises means for clamping a coin introduced through the return opening, preferably an upright edge, on activating an electromagnet which is in connection with the deflector and which brings the deflector into the retracted position, the coin located on the deflector is clamped such that the acceptance channel is not released and an authentic coin inserted through the insert slot is ejected together with the false coin through the return opening after the deactivation of the electromagnet. A manipulation of the coin tester is avoided in this manner.

### BRIEF DESCRIPTION OF THE DRAWING

One embodiment example of the invention is represented in the drawing, and is explained in more detail in the subsequent description. There are shown in:

FIG. 1 shows a perspective view of an electronic coin tester in a first position,

FIG. 2 shows a perspective view of an electronic coin tester in the opened condition, with a coin and deflector,

FIG. 3 shows a perspective view of a part of the coin tester with a return track, deflector, and a perspective view of the deflector, and

FIG. 4 shows schematic views of the deflector with housing walls in a section, in different positions.

### DETAILED DESCRIPTION OF THE INVENTION

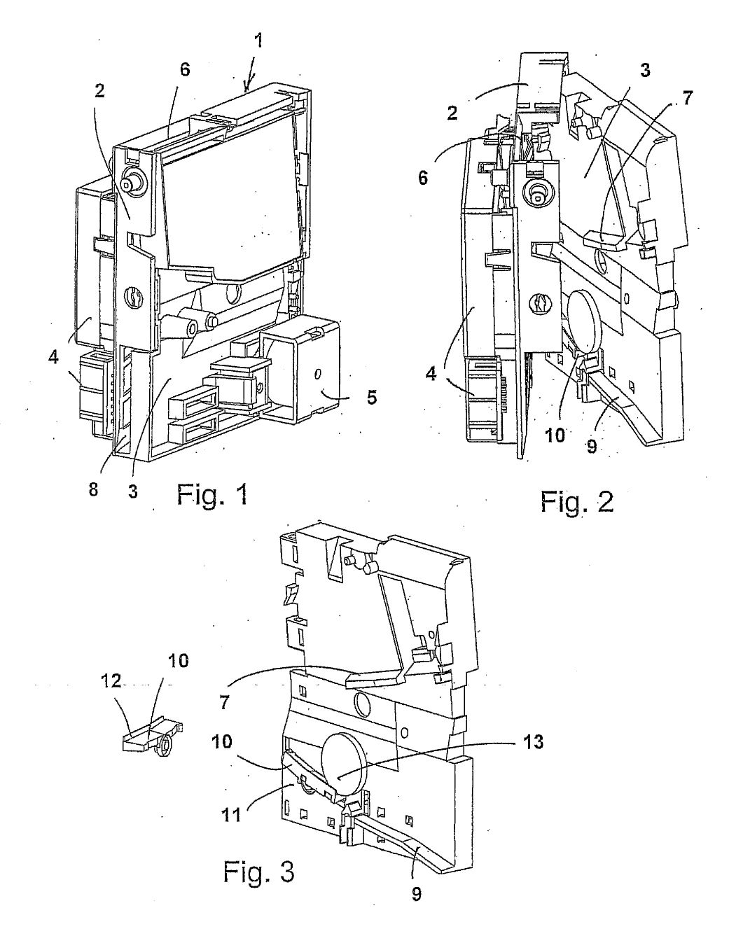

A coin tester is represented in FIG. 1, which comprises a housing 1 which consists of a base body 2 and a flap 3 covering the base body in a sandwich-like manner. The two component parts 2 and 3 are to be particularly well recognized in FIG. 2. The electrical, electronic and mechanical component parts 4, such as testing arrangements, control devices, circuit boards with electronic circuits and an electromagnet 5, are attached on the housing 1. A coin insert 6 is provided in the upper region of the housing 1, and a coin track 7 via which an inserted coin is led further, is formed in the flap 3. Test sensors which are not represented in more detail, are incorporated in the wall region of the coin track 7, and are connected to a control device. Furthermore, a return channel with a return opening 8 and a runner track 9 are to be recognized in FIG. 1 and FIG. 2, wherein the channel is formed by the runner track 9 and the delimiting housing walls.

A deflector 10 which is in connection with the electromagnet and is actuated between two positions by this, is inserted into the runner track 9 of the return channel. The deflector 10 is also shown in detail in FIG. 3. If the electromagnet 5 is in the idle position, i.e. is not activated, the deflector 10 is located in the position shown in FIGS. 2 and 3, i.e. is a component part of the runner track 9. When the electromagnet 5 is activated, which happens when a coin has been inserted into the insert slot 6 and acknowledged by testing devices that it is to be considered as a valid coin, the deflector is retracted, so that a acceptance channel 11 provided below the defector 10 is released.

As has already been specified, false coins with malicious intent are inserted through the return opening 8 by way of wire or other tools, wherein this false coin has fallen through the acceptance channel 11 on activation of the magnet 5. In order to prevent this, the deflector 10 is provided with an edge 12, which on excitation of the magnet 5, clamps a present coin, so that the acceptance channel 11 is not released.

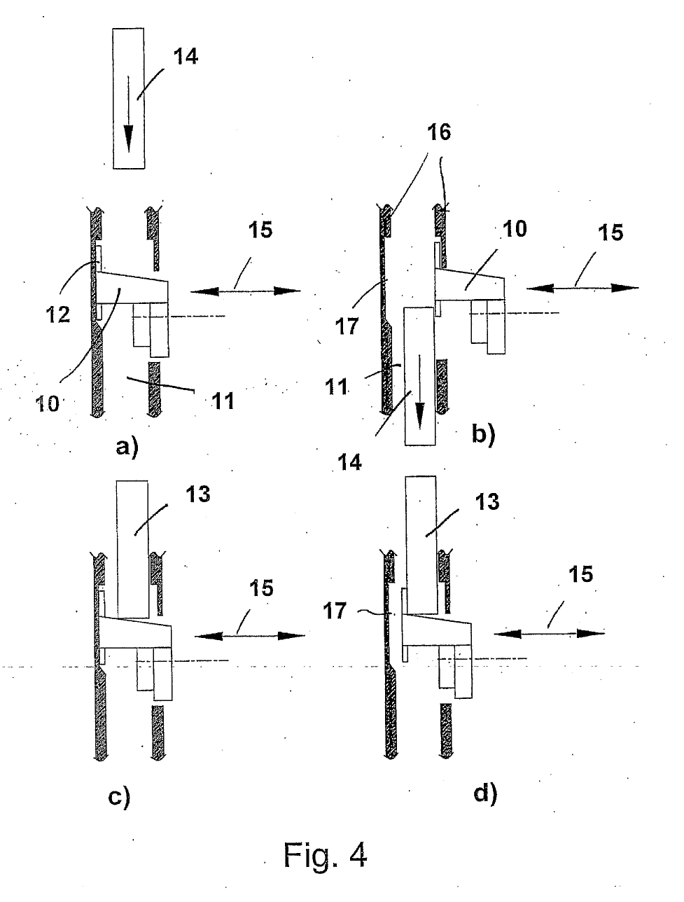

Such a manner of functioning may be recognized in more detail in FIG. 4 which represents a section through the deflector in the various positions. In FIG. 4a), a coin 14 recognized as being authentic is fed, and the deflector is retracted according to FIG. 4b), so that the coin 14 may get into the acceptance channel 11. If a false coin 13 is located on the deflector 10 or is held by a tool, and according to FIG. 4d) the deflector 10 is actuated (FIG. 4c), as is indicated basically by arrows 15, the edge 12 of the false coin 13 is clamped between the housing wall and the edge 12, so that the acceptance channel 11 continues to remain closed.

As may be recognized, recesses 17 are provided in the housing walls 16, in which the edge 12 is accommodated.

In the represented embodiment example, the edge 12 is designed as a continuous edge over the whole length of the deflector, but of course only webs or part elements of an edge may be provided.

1. An electronic coin tester, comprising:
a coin insert including a coin track;
at least one testing device examining the coin being situated in a region of the insert;
a deflector which depending on a result of the testing device, is brought into one of (a) a retracted position releasing an acceptance channel (b) an extended position, wherein when in the extended position, the coin is deflected into a return channel which ends in a return opening in a front region of the coin tester, wherein the deflector includes a clamping arrangement which on retraction of the deflector, clamp a false coin introduced via the return opening in the extended condition of the deflector.

2. The electronic coin tester according to claim 1, wherein the deflector is a strip-like runner element, which at least partly is provided with an upright edge realizing the clamping arrangement.

3. The electronic coin tester according to claim 2, wherein the strip-like runner element has a continuous upright edge.

4. The electronic coin tester according to claim 2, wherein the strip-like runner element is provided with several edge strips.

5. The electronic coin tester according to claim 2, wherein the housing walls in the region of the deflector includes recesses receiving the upright edge.

6. The electronic coin tester according to claim 1, wherein the deflector is in connection with an electromagnet, wherein in a non-activated condition, the deflector is a component part of the return channel, and in a activated condition, the deflector is retracted and releases the acceptance channel.
